(19) United States
(12) Patent Application Publication
(10) Pub. No.: US 2002/0096103 A1
(43) Pub. Date: Jul. 25, 2002

(54) Bookmark with flipping page holder

(76) Inventor: Richard E. Capstran, Milwaukee, WI (US)

Correspondence Address: Donald J. Ersler, 725 Garvens Avenue, Brookfield, WI, 53005, US

(21) Appl. No.: 09/766,088

(22) Filed: Jan. 19, 2001

(51) Int. Cl. B42D 9/00

(52) U.S. Cl. 116/234; 116/239; 281/42

(57) ABSTRACT

A bookmark with flipping page holder includes a base member, a retention projection, a flipping page holder, and a linkage member. The base member includes a side leg and a top leg. The retention projection extends downward from the top leg. Preferably, a linkage slot is formed along a width of the top leg at one end thereof. One end of the linkage member is attached to the flipping page holder and the other end of the linkage member is preferably slidably attached to the linkage slot.

### BACKGROUND OF THE INVENTION

1. Field of the Invention

The present invention relates generally to bookmarks and more specifically to a bookmark with a flipping page holder which may be operated with one hand or by individuals with limited movement in their arms or hands.

2. Discussion of the Prior Art

There are numerous designs of bookmarks which have been patented. However, it appears no bookmark exists which has a flipping page holder and which may be used with both soft and hard cover books. Two of the many bookmarks are Pat. No. 4,721,057 to Vigil and Pat. No. 4,838,198 to Knox. The Vigil patent discloses a loosely held page holder retained by an attachment clip. The attachment clip is capable of being fastened to a book cover. However, the page holder may not be easily swung to mark open pages.

Accordingly, there is a clearly felt need in the art for a bookmark with a flipping page holder which may be used with either soft or hard cover books and which has a page holder which remains with the book when not being used.

### SUMMARY OF THE INVENTION

The present invention provides a bookmark with a flipping page holder which remains with the book when not in use. The bookmark with flipping page holder includes a base member, a retention projection, a flipping page holder, and a linkage member. The base member includes a side leg and a top leg. The retention projection extends downward from the top leg and is spaced from the side leg to provide clearance for insertion into a hard or soft cover book. Preferably, a linkage slot is formed along a width of the top leg at one end thereof. One end of the linkage member is attached to the flipping page holder and the other end of the linkage member is slidably attached to the linkage slot. The retention projection is preferably inserted into a book such that the base member is adjacent a middle of the binding area of the book. When the reader is finished, they move the book in a swinging fashion such that the flipping page holder swings into open pages of the book.

Accordingly, it is an object of the present invention to provide a flipping page holder which may be used on either soft or hardcover books.

It is a further object of the present invention to provide a flipping page holder which may be operated with one hand.

It is yet a further object of the present invention to provide a flipping page holder which may be operated by someone with impaired arms or hands.

Finally, it is another object of the present invention to provide a flipping page holder which is retained by the book when not in use.

These and additional objects, advantages, features and benefits of the present invention will become apparent from the following specification.

### BRIEF DESCRIPTION OF THE DRAWINGS

FIG. 1 is a perspective view of a flipping page holder in accordance with the present invention.

FIG. 2 is a top of a flipping page holder inserted into a book in accordance with the present invention.

FIG. 3 is a cross sectional side view of a flipping page holder inserted into a book in accordance with the present invention.

### DETAILED DESCRIPTION OF THE PREFERRED EMBODIMENTS

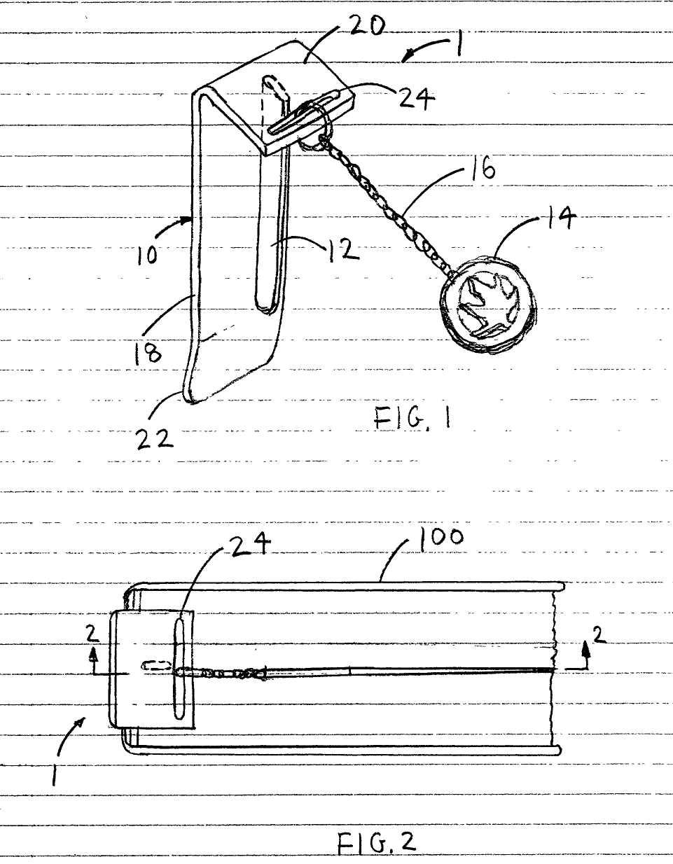

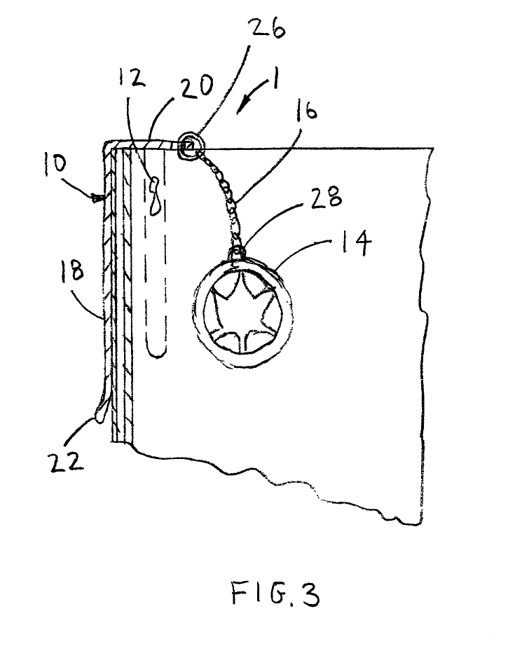

With reference now to the drawings, and particularly to FIG. 1, there is shown a perspective view of a bookmark with flipping page holder 1. With reference to FIGS. 2-3, the bookmark with flipping page holder 1 includes a base member 10, a retention projection 12, a flipping page holder 14, and a linkage member 16. The base member 10 includes a side leg 18 and a top leg 20. A bottom end 22 of the side leg 18 is preferably bent outward to facilitate insertion of the bookmark with flipping page holder 1. The retention projection 12 extends downward from the top leg 20 and is spaced from the side leg 18 to provide clearance for insertion into a hard or soft cover book. Preferably, the base member 10 and the retention projection 12 are formed from a single piece of material.

Preferably, a linkage slot 24 is formed along a width of the top leg 20 at one end thereof. Other opening shapes could also be used instead of the linkage slot 24. One end of the linkage member 16 is attached to the flipping page holder 14 and the other end of the linkage member 16 is slidably attached to the linkage slot 24. The linkage member 16 is preferably a chain terminated by a snap loop 26 on the other end. The snap loop 26 is slidably attached to the linkage slot 24 and the one end attached to a loop 28 or the like formed on the flipping page holder 14.

The retention projection 12 is preferably inserted into a book such that the base member 10 is adjacent a middle of the binding area of the book 100. When the reader is finished reading, they move the book in a swinging fashion such that the flipping page holder 14 swings into open pages of the book 100. If the linkage slot 24 is used, the base member 10 does not have to be reinserted to be close to open pages of the book 100.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A bookmark having a flipping page holder comprising:
a base member having a top leg and a side leg;
a retention projection extending downward from said top leg;
a flipping page holder; and
a linkage member having one end attached to said top leg and the other end attached to said flipping page holder.

2. The bookmark having a flipping page holder of claim 1 wherein:
a linkage slot being formed along a width of said top leg, said linkage member being slidably engaged with said linkage slot.

3. The bookmark having a flipping page holder of claim 1 wherein:
said linkage member being fabricated from a chain.

4. The bookmark having a flipping page holder of claim 1 wherein:
a bottom end of said side leg being bent outward to facilitate insertion of said bookmark with flipping page holder into a book.

5. A bookmark having a flipping page holder comprising:
a base member having a top leg and a side leg;
a retention projection extending downward from said top leg;
a flipping page holder;
a linkage slot being formed along a width of said top leg; and
a linkage member having one end slidably engaged with said linkage slot and the other end attached to said flipping page holder.

6. The bookmark having a flipping page holder of claim 5 wherein:
said linkage member being fabricated from a chain.

7. The bookmark having a flipping page holder of claim 5 wherein:
a bottom end of said side leg being bent outward to facilitate insertion of said bookmark with flipping page holder into a book.

8. A method of inserting a bookmark into a book with only one hand, comprising the steps of:
(a) providing a base member capable of being inserted into and retained by a book adjacent the binding area thereof;
(b) providing a page holder;
(c) providing a linkage member having one end attached to said base member and the other end attached to said page holder; and
(d) moving said book such that said page holder flips into open pages of the book.

9. The method of inserting a bookmark into a book with only one hand of claim 8 wherein:
said base member having a top leg and a side leg.

10. The method of inserting a bookmark into a book with only one hand of claim 9, further comprising:
a retention projection extending downward from said top leg.

11. The method of inserting a bookmark into a book with only one hand of claim 9 wherein:
a linkage slot being formed along a width of said top leg, said linkage member being slidably engaged with said linkage slot.

12. The method of inserting a bookmark into a book with only one hand of claim 8 where in:
said linkage member being fabricated from a chain.

13. The method of inserting a bookmark into a book with only one hand of claim 9 wherein:
a bottom end of said side leg being bent outward to facilitate insertion of said bookmark with flipping page holder into a book.
